(19) United States
(12) Patent Application Publication
(10) Pub. No.: US 2020/0263982 A1
(43) Pub. Date: Aug. 20, 2020

(54) ROAD SURFACE INCLINATION ANGLE MEASURING DEVICE AND ROAD SURFACE INCLINATION ANGLE MEASURING METHOD

(71) Applicant: RATIO LLC., Goyang-si (KR)

(72) Inventor: Hyo Jung LEE, Seongnam-si (KR)

(21) Appl. No.: 16/647,425

(22) PCT Filed: Aug. 1, 2018
(86) PCT No.: PCT/KR2018/008748

§ 371 Date: Mar. 13, 2020

(30) Foreign Application Priority Data
Sep. 15, 2017 (KR) 10-2017-0118382

(51) Int. Cl. G01C 9/02; G01S 19/47; G01C 22/00

(52) U.S. Cl. CPC G01C 9/02; G01C 22/002; G01S 19/47

(57) ABSTRACT

A road surface inclination angle measuring device and a road surface inclination angle measuring method capable of accurately measuring a road surface inclination angle even when the road surface inclination angle measuring device is not horizontally installed on a moving means.

### CROSS REFERENCE TO RELATED APPLICATION

This application is a National Stage Entry of International Application No. PCT/KR2018/008748, filed on Aug. 1, 2018, and claims priority from and the benefit of Korean Patent Application No. 10-2017-0118382, filed on Sep. 19, 2017, each of which is hereby incorporated by reference for all purposes as if fully set forth herein.

### BACKGROUND

### Field

The present invention relates to a road surface inclination angle measuring device provided in a moving means and a road surface inclination angle measuring method, and more particularly, to a road surface inclination angle measuring device and a road surface inclination angle measuring method capable of accurately measuring the road surface inclination angle even when the road surface inclination angle measuring device is not horizontally installed on the moving means.

### Discussion of the Background

Recently, as a bike market has been gentrified, a demand for a bike computer that is attached to a moving means such as a bicycle and provides various convenience functions is increasing. The bike computer refers to an electronic device that collects, calculates and displays various types of information about riding, such as speed.

Meanwhile, a demand of bike riders who want to know information about inclination angles of roads that bike riders are currently riding is gradually increasing, and accordingly, a demand for the addition of an inclination angle measurement function to the bike computer tends to gradually increase.

As shown in FIG. 1A, when a bike computer with an embedded inclination angle measurement function is mounted horizontally on a bike (see (1)), and climbs an inclination with a ground inclination angle θ (see (2)), according to a method of FIG. 1B, the ground inclination angle may be measured. When the bike computer is provided with a gravity sensor or an acceleration sensor capable of detecting the vertical direction, as shown in FIG. 1B, the bike computer may easily measure ground inclination angle θ by measuring a vector [symbol] of the gravity direction and obtaining an angle formed by the vector [symbol] of the gravity direction and a predetermined reference axis (e.g., a central axis z of the bike computer).

However, the bike computer is typically attached to a handlebar of the bike, and a rider adjusts the angle to install the bike computer such that a screen of the bike computer may be seen well. That is, in consideration of the normal usage of the bike computer, the bike computer is mostly installed on the bike obliquely at an angle other than the horizontal direction. For example, as shown in FIG. 1C, when the bike computer is installed on the bike with an inclination angle δ (see (1)), and climbs the inclination with the ground inclination angle θ (see (2)), if the ground inclination angle is measured according to the above-described method (the method of obtaining the angle formed by the vector [symbol] of the gravity direction and the predetermined reference axis (e.g., the central axis z of the bike computer)), as shown in FIG. 1D, an error equal to an installation inclination δ of the bike computer occurs compared to the actual ground inclination angle θ.

That is, due to the installation inclination of the bike computer, there occurs a problem in that it is difficult to accurately measure the ground inclination angle using the method of measuring the ground inclination angle by obtaining the angle between the vector of the direction of gravity and the predetermined reference axis.

The above information disclosed in this Background section is only for understanding of the background of the inventive concepts, and, therefore, it may contain information that does not constitute prior art.

### SUMMARY OF THE INVENTION

The present invention has been made in view of the above-mentioned problems occurring in the prior art, and it is an object of the present invention to provide a road surface inclination angle measuring device and a road surface inclination angle measuring method capable of accurately measuring the road surface inclination angle even when the road surface inclination angle measuring device is not horizontally installed on the moving means.

Additional features of the inventive concepts will be set forth in the description which follows, and in part will be apparent from the description, or may be learned by practice of the inventive concepts.

To accomplish the above-mentioned objects, according to the present invention, there is provided a road surface inclination angle measuring device which is installed in a moving means and measures an instant road surface inclination angle includes a first sensor module configured to measure data for calculating a moving distance; a second sensor module configured to measure data for calculating an altitude; a third sensor module configured to measure data for calculating an instant inclination of the road surface inclination angle measuring device; and a calculation module configured to calculate the instant road surface inclination angle θ at a predetermined measurement time tₙ, wherein the calculation module includes a moving distance calculation module configured to calculate a moving distance d from a predetermined initial time t₀ to the measurement time tₙ based on the data measured by the first sensor module; an altitude difference calculation module configured to calculate an altitude difference h that is a difference between an altitude at the initial time t₀ and an altitude at the measurement time tₙ based on the data measured by the second sensor module; an average road surface inclination angle calculation module configured to calculate an average road surface inclination angle α based on the moving distance d and the altitude difference h; an average inclination calculation module configured to calculate an average inclination β which is an average value of instant inclinations of the road surface inclination angle measuring device, based on the data measured by the third sensor module from the initial time t₀ to the measurement time tₙ; and an instant road surface inclination angle calculation module configured to calculate the instant road surface inclination angle θ at the measurement time tₙ based on the average road surface inclination angle α, the average inclination β, and the instant inclination of the road surface inclination angle measuring device calculated based on the data measured at the measurement time tₙ by the third sensor module.

The instant road surface inclination angle calculation module may calculate the instant road surface inclination angle θ at the measurement time tₙ by correcting the instant inclination of the road surface inclination angle measuring device calculated at the measurement time tₙ to an installation inclination δ of the road surface inclination angle measuring device, and the installation inclination δ of the road surface inclination angle measuring device may be a difference value between the average inclination β and the average road surface inclination angle α.

The first sensor module may include a sensor configured to measure speed data, and the moving distance calculation module may calculate the moving distance d from the initial time t₀ to the measurement time tₙ based on speed data measured by the first sensor module from the initial time t₀ to the measurement time tₙ.

The first sensor module may include a sensor configured to measure a global positioning system (GPS) data, and the moving distance calculation module may calculate the moving distance d from the initial time t₀ to the measurement time tₙ based on GPS data measured by the first sensor module at the initial time t₀ and GPS data measured by the first sensor module at the measurement time tₙ.

The second sensor module may be an air pressure sensor.

The third sensor module may be an acceleration sensor.

According to the present invention, there is provided a road surface inclination angle measuring device which is installed in a moving means and measures an instant road surface inclination angle, the road surface inclination angle measuring device including a sensor module configured to measure first data for calculating a moving distance, measure second data for calculating an altitude, and measure third data for calculating an instant inclination of the road surface inclination angle measuring device; and a calculation module configured to calculate the instant road surface inclination angle at a predetermined measurement time, wherein the calculation module includes a moving distance calculation module configured to calculate a moving distance from a predetermined initial time to the measurement time based on the first data measured by the sensor module; an altitude difference calculation module configured to calculate an altitude difference that is a difference between an altitude at the initial time and an altitude at the measurement time based on the second data measured by the sensor module; an average road surface inclination angle calculation module configured to calculate an average road surface inclination angle based on the moving distance and the altitude difference; an average inclination calculation module configured to calculate an average inclination which is an average value of instant inclinations of the road surface inclination angle measuring device, based on the third data measured by the sensor module from the initial time to the measurement time; and an instant road surface inclination angle calculation module configured to calculate the instant road surface inclination angle at the measurement time based on the average road surface inclination angle, the average inclination, and the instant inclination of the road surface inclination angle measuring device calculated based on the third data measured at the measurement time by the sensor module.

According to the present invention, there is provided a road surface inclination angle measuring method performed by a road surface inclination angle measuring device which is installed in a moving means, the road surface inclination angle measuring device including a first sensor module configured to measure data for calculating a moving distance; a second sensor module configured to measure data for calculating an altitude; a third sensor module configured to measure data for calculating an instant inclination of the road surface inclination angle measuring device, the road surface inclination angle measuring method including moving distance calculation step of calculating a moving distance d from a predetermined initial time t₀ to a predetermined measurement time tₙ based on the data measured by the first sensor module; altitude difference calculation step of calculating an altitude difference h that is a difference between an altitude at the initial time t₀ and an altitude at the measurement time tₙ based on the data measured by the second sensor module; average road surface inclination angle calculation step of calculating an average road surface inclination angle α based on the moving distance d and the altitude difference h; average inclination calculation step of calculating an average inclination β which is an average value of instant inclinations of the road surface inclination angle measuring device, based on the data measured by the third sensor module from the initial time t₀ to the measurement time tₙ; and instant road surface inclination angle calculation step of calculating the instant road surface inclination angle θ at the measurement time tₙ based on the average road surface inclination angle α, the average inclination β, and the instant inclination of the road surface inclination angle measuring device calculated based on the data measured at the measurement time tₙ by the third sensor module.

The instant road surface inclination angle calculation step may include calculating the instant road surface inclination angle θ at the measurement time tₙ by correcting the instant inclination of the road surface inclination angle measuring device calculated at the measurement time tₙ to an installation inclination δ of the road surface inclination angle measuring device, and the installation inclination of the road surface inclination angle measuring device δ is a difference value between the average inclination β and the average road surface inclination angle α.

According to the present invention, there is provided a road surface inclination angle measuring method performed by a road surface inclination angle measuring device which is installed in a moving means, the road surface inclination angle measuring device including a sensor module configured to measure first data for calculating a moving distance, measure second data for calculating an altitude, and measure third data for calculating an instant inclination of the road surface inclination angle measuring device, the road surface inclination angle measuring method including moving distance calculation step of calculating a moving distance from a predetermined initial time to the measurement time based on the first data measured by the sensor module; altitude difference calculation step of calculating an altitude difference that is a difference between an altitude at the initial time and an altitude at the measurement time based on the second data measured by the sensor module; average road surface inclination angle calculation step of calculating an average road surface inclination angle based on the moving distance and the altitude difference; average inclination calculation step of calculating an average inclination which is an average value of instant inclinations of the road surface inclination angle measuring device, based on the third data measured by the sensor module from the initial time to the measurement time; and instant road surface inclination angle calculation step of calculating the instant road surface inclination angle at the measurement time based on the average road surface inclination angle, the average inclination, and the instant inclination of the road surface inclination angle measuring device calculated based on the third data measured at the measurement time by the sensor module.

According to the present invention, there is provided a computer program installed in a data processing device and stored in a recording medium for performing the above-described method.

According to the present invention, there is provided a road surface inclination angle measuring device which is installed in a moving means, the road surface inclination angle measuring device including a sensor module configured to measure first data for calculating a moving distance, measure second data for calculating an altitude, and measure third data for calculating an instant inclination of the road surface inclination angle measuring device; a processor; and a memory storing a computer program executed by the processor, wherein the computer program allows the road surface inclination angle measuring device to perform the above-described method when the computer program is executed by the processor.

According to the present invention, a road surface inclination angle measuring device and a road surface inclination angle measuring method capable of accurately measuring the road surface inclination angle even when the road surface inclination angle measuring device is not horizontally installed on the moving means may be provided.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIGS. 1A, 1B, 1C, and 1D are diagrams for explaining a problem of a conventional road surface inclination angle measuring method.

FIG. 2 is a block diagram showing a schematic configuration of a road surface inclination angle measuring device according to an embodiment of the present invention.

FIG. 3 is a block diagram showing a schematic configuration of a calculation module according to an embodiment of the present invention.

FIG. 4 is a diagram for explaining a method of calculating an average road surface inclination angle.

FIG. 5 is a diagram for explaining a method of calculating an average value of an instant inclination of a road surface inclination angle measuring device.

FIG. 6 is a flowchart illustrating a road surface inclination angle measuring method according to an exemplary embodiment of the present invention.

### DETAILED DESCRIPTION

As the invention allows for various changes and numerous embodiments, exemplary embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of the related art are omitted when it is deemed that they may unnecessarily obscure the essence of the invention.

While such terms as “first,” “second,” etc., may be used to describe various components, such components must not be limited to the above terms. The above terms are used only to distinguish one component from another.

The terms used in the present specification are merely used to describe exemplary embodiments, and are not intended to limit the present invention. An expression used in the singular encompasses the expression of the plural, unless it has a clearly different meaning in the context.

In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, in the present specification, when one component ‘transmits’ data to another component, it means that the component may directly transmit the data to the other component, or the data may be transmitted to the other component through at least one other component. On the contrary, when one component ‘directly transmits’ data to another component, it means that the data is transmitted from the component to the other component without going through the other component.

Hereinafter, the present invention will be described in detail by explaining preferred embodiments of the invention with reference to the attached drawings. Like reference numerals in the drawings denote like elements.

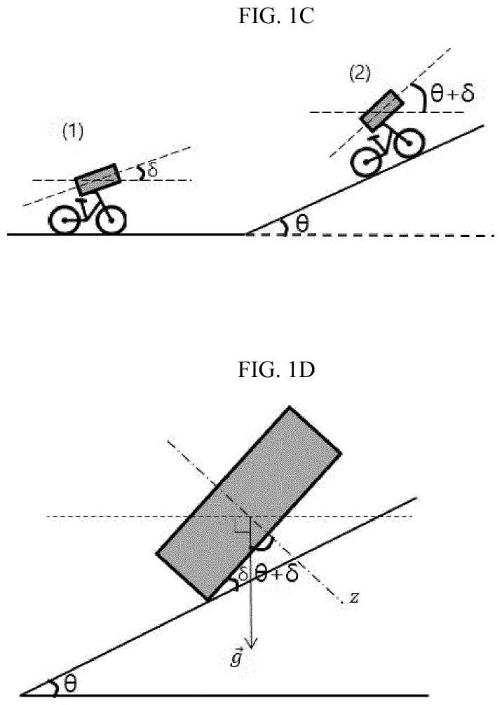

FIG. 2 is a block diagram schematically showing a structure of a road surface inclination angle measuring device 100 according to an embodiment of the present invention.

The road surface inclination angle measuring device 100 may be installed in a moving means. The moving means may be a bicycle, a motorcycle, an electric wheel, a segway, a vehicle, a kickboard, or the like.

The road surface inclination angle measuring device 100 may calculate or estimate the inclination angle (the instant road inclination angle) of a road surface on which the moving means is located at a predetermined measurement time, and display information about the calculated road surface inclination angle or transmit the information to another device.

The road surface inclination angle measuring device 100 may be an information processing device or in the form of a combination of the information processing device and software installed in the information processing device.

The road surface inclination angle measuring device 100 may be an independent device or a subsystem mounted in another system. For example, the road surface inclination angle measuring device 100 may be a bike computer or a subsystem mounted on the bike computer.

The road surface inclination angle measuring device 100 may include a sensor module 110 and a calculation module 120 as shown in FIG. 2.

According to an embodiment of the present invention, some of the above components may not necessarily correspond to the components necessary for the implementation of the present invention, and the road surface inclination angle measuring device 100 may also include more components than those according to an embodiment. For example, the road surface inclination angle measuring device 100 may further include a display module (not shown) for displaying a measured value and a control module (not shown) controlling the function and/or resource of another component (e.g., the sensor module 110 and and/or the calculation module 120) constituting the road surface inclination angle measuring device 100.

The road surface inclination angle measuring device 100 may include hardware resource and/or software necessary for implementing the technical idea of the present invention, and does not necessarily mean one physical component or one device. That is, the road surface inclination angle measuring device 100 may mean a logical combination of hardware and/or software necessary for implementing the technical idea of the present invention, and, if necessary, may be installed in devices spaced apart from each other to perform each function and thus implemented as a set of logical components for implementing the technical idea of the present invention. In addition, the road surface inclination angle measuring device 100 may mean a set of components separately implemented for each function or role for implementing the technical idea of the present invention.

In addition, a module in the present specification may mean a functional and structural combination of hardware for performing the technical idea of the present invention and software for driving the hardware. For example, it may be easily inferred by the average expert in the art that the module may mean a logical unit of a predetermined code and a hardware resource for performing the predetermined code, and does not necessarily mean a physically connected code or a kind of hardware.

The sensor module 110 may include at least one sensor for measuring first data for calculating a moving distance, second data for calculating an altitude, and third data for calculating an instant inclination of the road surface inclination angle measuring device 100.

For example, as shown in FIG. 2, the sensor module 110 may include a first sensor module 111 for measuring the first data for calculating the moving distance, a second sensor module 112 for measuring the second data for calculating the altitude, and a third sensor module 113 for measuring the third data for calculating the instant inclination of the road surface inclination angle measuring device 100.

However, the sensor module 110 of FIG. 2 is merely an example, and one sensor may physically measure two or more data. For example, a GPS sensor may measure both the first data for calculating the moving distance and the second data for calculating the altitude. Alternatively, the sensor module 110 may be in the form of one sensor for measuring all of the first data for calculating the moving distance, the second data for calculating the altitude, and the third data for calculating the instant inclination.

Alternatively, the first data, second data or third data may be a combination of measurement values measured from two or more sensors.

Hereinafter, for the convenience of description, an example in which the sensor module 110 includes the first sensor module 111, the second sensor module 112, and the third sensor module 113 will be described but it will be easily understood by one of ordinary skill in the art that the first sensor module 111, the second sensor module 112, and the third sensor module 113 are not necessarily physically separated components.

Referring to FIG. 2, the first sensor module 111 may be a sensor for measuring data calculating the moving distance.

In an embodiment, the first sensor module 111 may be a sensor for measuring the speed. In this case, the moving distance may be determined by the speed and a measurement period.

In another embodiment, the first sensor module 111 may be a sensor (e.g., a GPS module) for measuring a position. In this case, the moving distance may be calculated from position (coordinate) data between two points.

In another embodiment, the first sensor module 111 may be a sensor (for example, a tachometer) for measuring the number of revolutions of a wheel of the moving means. Since a moving distance per one revolution of the wheel provided by the moving means is a determined value, the moving distance of the moving means may be measured by measuring the number of revolutions.

Alternatively, the first sensor module 111 may be a combination of a GPS module, a speed sensor, and/or a tachometer.

The second sensor module 112 may be a sensor for measuring data for calculating the altitude.

In an embodiment, the second sensor module 112 may be an air pressure sensor for measuring the barometric pressure. In this case, the altitude may be calculated by using a mapping table that defines the relationship between the air pressure and the altitude or comparing the air pressure at a reference altitude and the measured air pressure.

In another embodiment, the second sensor module 112 may be a sensor (e.g., a GPS module) for measuring the altitude.

Alternatively, the second sensor module 112 may be a combination of an air pressure sensor and a GPS module.

The third sensor module 113 may be a sensor for measuring data for calculating the instant inclination of the road surface inclination angle measuring device 100.

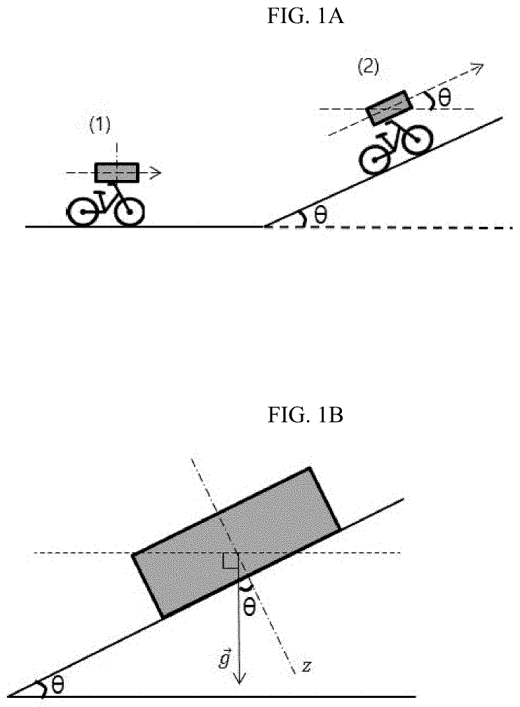

For example, the third sensor module 113 may be an acceleration sensor. The acceleration sensor may be called a gravity sensor. A method of calculating the inclination of the road surface inclination angle measuring device 100 through the acceleration sensor is the same as described above with reference to FIGS. 1A to 1D. That is, the inclination of the road surface inclination angle measuring device 100 may be calculated by obtaining a vector of the gravity direction through the acceleration sensor and using an angle formed by the vector of the gravity direction and a predetermined reference axis (e.g., the vertical axis or the horizontal axis of the road surface inclination angle measuring device 100).

The calculation module 120 may receive the data measured by each of the sensor modules 111, 112, and 113 from the sensor module 110 or may control the first sensor module 111, the second sensor module 112, and the third sensor module 113.

In addition, the calculation module 120 may calculate the instant road surface inclination angle θₙ at a predetermined measurement time tₙ.

In addition, the calculation module 120 may calculate the instant road surface inclination angle θₙ at a measurement time equivalent to the corresponding period at regular time intervals for a predetermined period.

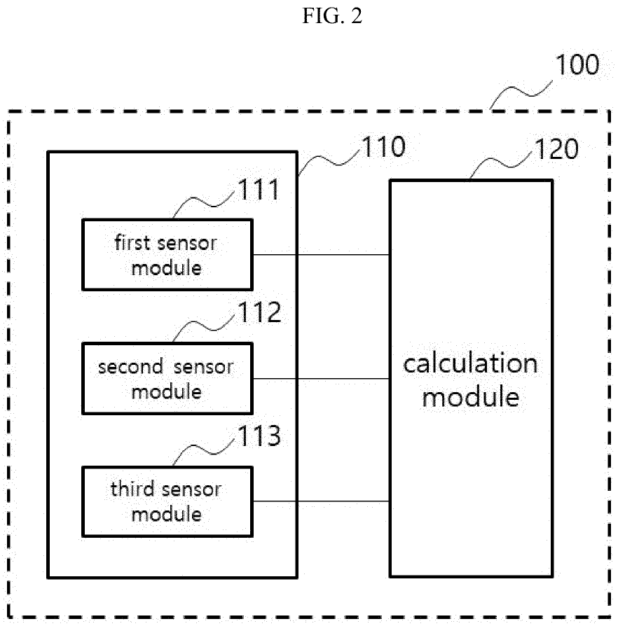

FIG. 3 is a block diagram schematically showing a detailed configuration of the calculation module 120 according to an embodiment of the present invention.

Referring to FIG. 3, the calculation module 120 may include a moving distance calculation module 121, an altitude difference calculation module 122, an average road surface inclination angle calculation module 123, an average inclination calculation module 124, and an instant road surface inclination angle calculation module 125.

The moving distance calculation module 121 may calculate a moving distance d from a predetermined initial time t₀ to the measurement time tₙ based on data measured by the first sensor module 111.

The altitude difference calculation module 122 may calculate an altitude difference h that is a difference between the altitude at the initial time t₀ and the altitude at the measurement time tₙ based on data measured by the second sensor module 112.

The average road surface inclination angle calculation module 123 may calculate an average road surface inclination angle α based on the moving distance d and the altitude difference h.

The initial time t₀ may be, for example, a time at which a predetermined command (e.g., a reset command, a measurement start command, etc.) is input to the road surface inclination angle measuring device 100.

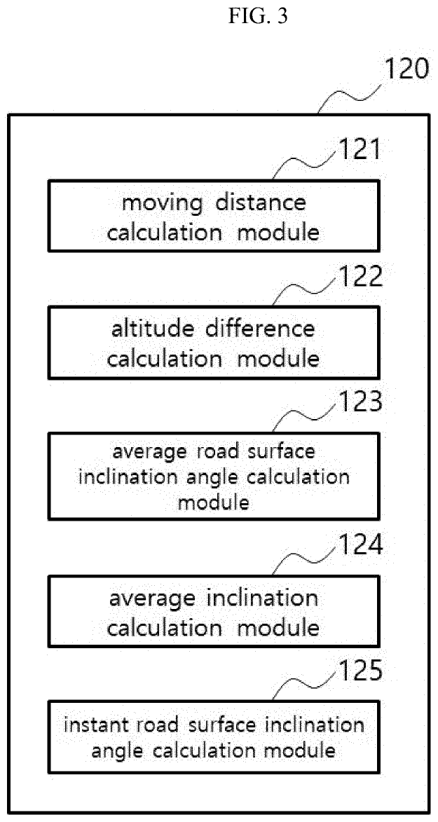

Hereinafter, a method of calculating the average road surface inclination angle α will be described in more detail with reference to FIG. 4.

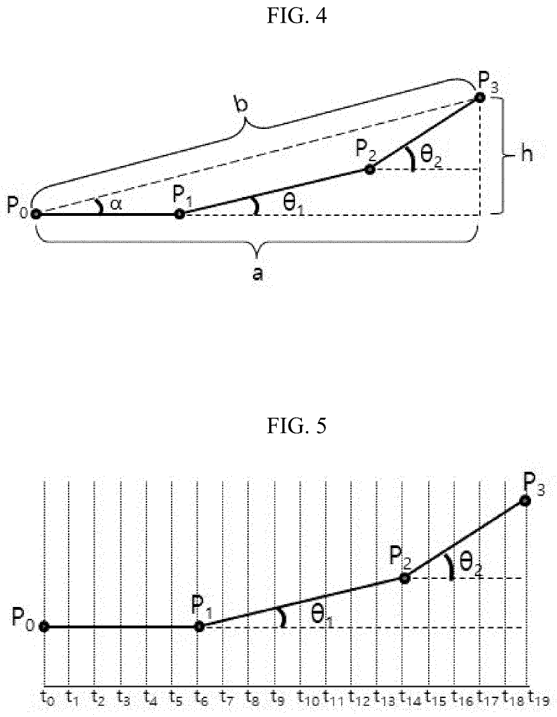

In the examples of FIG. 4 and FIG. 5 to be described later, it is assumed that a moving means in which the road surface inclination angle measuring device 100 is installed starts at P₀ at the initial time t₀, passes through points P₁ and P₂, and moves to a point P₃ at the measurement time tₙ, a period P₀-P₁ is horizontal, the road surface inclination angle of a period P₁-P₂ is θ₁, and the road surface inclination angle of a period P₂-P₃ is θ₂.

If the first sensor module 111 includes a sensor for measuring speed data, the moving distance calculation module 121 may calculate the moving distance d from the initial time t₀ to the measurement time tₙ based on the speed data measured by the first sensor module 111 from the initial time t₀ to the measurement time tₙ.

In this case, in the example of FIG. 4, the moving distance d calculated by the moving distance calculating module 121 may be a distance of the period P₀-P₁+a distance of the period P₁-P₂+a distance of the period P₂-P₃.

Meanwhile, as described above, the altitude difference calculation module 122 may calculate the altitude difference h that is the difference between the altitude at the initial time t₀ and the altitude at the measurement time tₙ based on data measured by the second sensor module 112.

Then, the average road surface inclination angle calculation module 123 may calculate the average road surface inclination angle α based on the moving distance d and the altitude difference h.

In the example of FIG. 4, the moving distance d calculated by the moving distance calculating module 121 may be regarded as a value approximating a horizontal distance a between the starting point (the point P₀) and the measuring point (the point P₃), and thus the average road surface inclination angle calculation module 123 may calculate the average road surface inclination angle α through the following Equation 1.

tan α=h/d [Equation 1]

Alternatively, the moving distance d calculated by the moving distance calculating module 121 may be regarded as a value approximating a straight line distance b between the starting point (the point P₀) and the measuring point (the point P₃), and thus the average road surface inclination angle calculation module 123 may calculate the average road surface inclination angle α through the following Equation 2.

sin α=h/d [Equation 2]

Alternatively, the average road surface inclination angle calculation module 123 may calculate the average road surface inclination angle α through the following Equation 3, which is an approximation equation when α is very small.

α=h/d [Equation 3]

If the first sensor module 111 includes a sensor for measuring GPS data, the moving distance calculation module 121 may calculate the moving distance d from the initial time t₀ to the measurement time tₙ based on the GPS data measured by the first sensor module 111 at the initial time t₀ and the GPS data measured by the first sensor module 111 at the measurement time tₙ.

In the example of FIG. 4, if the moving distance d calculated by the moving distance calculating module 121 is the horizontal distance a between the starting point (the point P₀) and the measuring point (the point P₃), the average road surface inclination angle calculation module 123 may calculate the average road surface inclination angle α through Equation 1.

tan α=h/d [Equation 1]

Alternatively, if the moving distance d calculated by the moving distance calculating module 121 is the straight line b between the starting point (the point P₀) and the measuring point (the point P₃), the average road surface inclination angle calculation module 123 may calculate the average road surface inclination angle α through the Equation 2.

sin α=h/d [Equation 2]

Referring back to FIG. 3, the average inclination calculation module 124 may calculate an average inclination β which is an average value of the instant inclination of the road surface inclination angle measuring device 100 based on data measured by the third sensor module 113 from the initial time t₀ to the measurement time tₙ.

To this end, the average inclination calculation module 124 may receive the data measured by the third sensor module 113 at a cycle of a predetermined time interval (for example, 1 s, 10 ms, etc.) or every predetermined moving distance (for example, 1 m, 5 m, etc.) from the initial time t₀ to the measurement time tₙ, calculate the instant inclination of the road surface inclination angle measuring device 100 at the corresponding time whenever receiving the data, and calculate an average value of the instant inclinations. A method of calculating the instant inclination of the road surface inclination angle measuring device 100 at a specific time has been described above with reference to FIG. 4.

Hereinafter, a method performed by the average inclination calculation module 124 of calculating the average inclination β, which is the average value of instant inclinations of the road surface inclination angle measuring device 100, will be described with reference to FIG. 5. It is assumed that the road surface inclination angle measuring device 100 is installed at an inclination of the angle δ in the moving means.

As shown in FIG. 5, while the moving means in which the road surface inclination angle measuring device 100 is installed moves from the initial time t₀ to a measurement time t₁₉, if the average inclination calculation module 124 calculates the instant inclination of the road surface inclination angle measuring device 100 at t₀, t₁, t₂, t₃, . . . , t₁₈ and t₁₉, an instant inclination ψᵢ of the road surface inclination angle measuring device 100 calculated at a time tᵢ (0<=i<=19) is theoretically as follows.

ψ₀=ψ₁=ψ₂=ψ₃=ψ₄=ψ₅=ψ₆=0+δ

ψ₇=ψ₈=ψ₉=ψ₁₀=ψ₁₁=ψ₁₂=ψ₁₃=ψ₁₄=θ₁+δ

ψ₁₅=ψ₁₆=ψ₁₇=ψ₁₈=ψ₁₉=θ₂+δ

The average inclination calculation module 124 may calculate the average value β of the instant inclination ψᵢ of the road surface inclination angle measuring device 100 calculated every time tᵢ (0<=i<=19) as follows.

β=Sigma(ᵢ [symbol] _{0 to 19})(ψᵢ)/20=δ+(8θ₁+5θ₂)/20

(The general equation for calculating the average value β is β=Sigma(ᵢ [symbol] _{0 to n})(ψₙ)/(n+1))

Referring back to FIG. 3, the instant road surface inclination angle calculation module 125 may calculate the instant road surface inclination angle θₙ at the measurement time tₙ based on the calculated average road surface inclination angle α and average inclination β, and the instant inclination ψₙ of the road surface inclination angle measuring device 100 calculated is based on the data measured at the measurement time tₙ by the third sensor module 113 as described above.

More specifically, the instant road surface inclination angle calculation module 125 may determine a difference value between the average inclination β and the average road surface inclination angle α as an installation inclination δ of the road surface inclination angle measuring device 100 (that is, δ=β−α).

Accordingly, the instant road surface inclination angle calculation module 125 may correct the instant inclination ψₙ of the road surface inclination angle measuring device 100 measured at the measurement time tₙ to the installation inclination δ (i.e., the difference value between the average inclination β and the average road surface inclination angle α) of the road surface inclination angle measuring device 100 to calculate the instant road surface inclination angle θ at the measurement time tₙ (i.e., θ=ψₙ−δ).

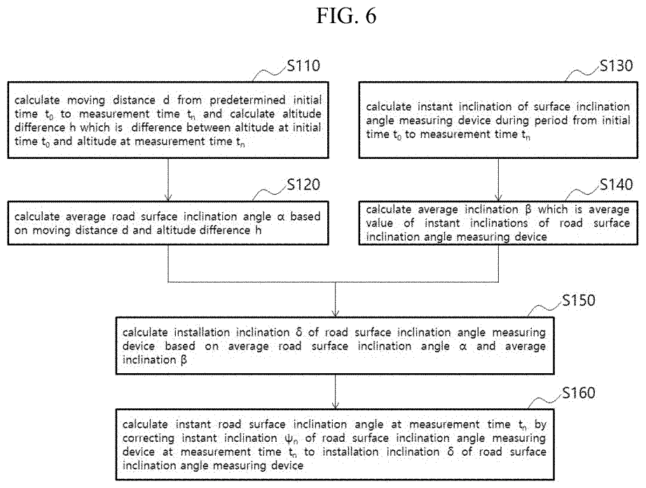

FIG. 6 is a flowchart illustrating a road surface inclination angle measuring method according to an embodiment of the present invention.

Referring to 6, the road surface inclination angle measuring device 100 may calculate the moving distance d from the predetermined initial time t₀ to the measurement time tₙ based on data measured by the first sensor module 111, and may calculate the altitude difference h which is a difference between the altitude at the initial time t₀ and the altitude at the measurement time tₙ based on data measured by the second sensor module 112 (S110).

Thereafter, the road surface inclination angle measuring device 100 may calculate the average road surface inclination angle α based on the moving distance d and the altitude difference h (S120).

On the other hand, the road surface inclination angle measuring device 100 may calculate an instant inclination of the surface inclination angle measuring device 100 based on data measured by the third sensor module 113 during a period from the initial time t₀ to the measurement time tₙ (S130). For example, the road surface inclination angle measuring device 100 may calculate the instant inclination of the road surface inclination angle measuring device 100 at a cycle of a predetermined time interval or every predetermined moving distance (S130).

Thereafter, the road surface inclination angle measuring device 100 may calculate the average inclination β which is an average value of instant inclinations of the road surface inclination angle measuring device 100 calculated in step S130.

Thereafter, the road surface inclination angle measuring device 100 may calculate the inclination inclination δ of the road surface inclination angle measuring device 100 based on the average road surface inclination angle α and the average inclination β.

In addition, the road surface inclination angle measuring device 100 may correct the instant inclination ψₙ of the road surface inclination angle measuring device 100 at the measurement time tₙ to the installation inclination δ of the road surface inclination angle measuring device 100 to calculate the road surface inclination angle at the measurement time tₙ.

According to an implementation example, the road surface inclination angle measuring device 100 may include a processor and a memory that stores a program executed by the processor. The processor may include a single core CPU or a multi core CPU. The memory may include fast random access memory and may include nonvolatile memory, such as one or more magnetic disk storage devices, flash memory devices, or other nonvolatile solid state memory devices. Access to the memory by the processor and other components may be controlled by a memory controller. Here, when the program is executed by the processor, the program may allow the road surface inclination angle measuring device 100 according to the present embodiment to perform the above-described parking information providing method.

On the other hand, the road surface inclination angle measuring method according to an embodiment of the present invention may be stored in a computer-readable recording medium that is implemented in the form of a computer-readable program command, and the control program and the target program according to an embodiment of the present invention may also be stored in the computer-readable recording medium. The computer-readable recording medium includes all kinds of recording devices that store data that may be read by a computer system.

The program instructions recorded on the recording medium may be those specially designed and configured for the present invention, or may be known and available to those skilled in the software art.

Examples of the computer-readable recording medium include magnetic media such as hard disks, floppy disks, and magnetic tape, optical media such as CD-ROMs, and DVDs, magneto-optical media such as floptical media, and hardware devices specially configured to store and execute the program instructions such as ROM, RAM, flash memory and the like. Also, the computer-readable recording medium may also be distributed over networked computer systems such that the computer-readable code may be stored and executed in a distributed fashion.

Examples of program instructions include machine language codes such as those produced by a compiler, as well as devices that process information electronically using an interpreter, for example, high-level language code that may be executed by a computer.

The hardware device described above may be configured to operate as one or more software modules to perform the operations of the present invention, and vice versa.

The above description of the present invention is intended for illustration, and it will be understood by those skilled in the art that the present invention may be easily modified in other specific forms without changing the technical spirit or essential features of the present invention. Therefore, the embodiments described above are to be understood in all respects as illustrative and not restrictive. For example, each component described as a single form may be implemented in a distributed manner, and similarly, components described as being distributed may also be implemented in a combination form.

The scope of the present invention is presented by the following claims rather than the above description, and all changes or modifications derived from the meaning and scope of the claims and their equivalents should be construed as being included in the scope of the present invention.

1. A road surface inclination angle measuring device installed in a moving object and configured to measure an instant road surface inclination angle, the road surface inclination angle measuring device comprising:
a first sensor module configured to measure data for calculating a moving distance;
a second sensor module configured to measure data for calculating an altitude;
a third sensor module configured to measure data for calculating an instant inclination of the road surface inclination angle measuring device; and
a calculation module configured to calculate the instant road surface inclination angle at a predetermined measurement time,
wherein the calculation module comprises:
a moving distance calculation module configured to calculate a moving distance from a predetermined initial time to the measurement time based on the data measured by the first sensor module;
an altitude difference calculation module configured to calculate an altitude difference that is a difference between an altitude at the initial time and an altitude at the measurement time based on the data measured by the second sensor module;
an average road surface inclination angle calculation module configured to calculate an average road surface inclination angle based on the moving distance and the altitude difference;
an average inclination calculation module configured to calculate an average inclination which is an average value of instant inclinations of the road surface inclination angle measuring device, based on the data measured by the third sensor module from the initial time to the measurement time; and
an instant road surface inclination angle calculation module configured to calculate the instant road surface inclination angle at the measurement time based on the average road surface inclination angle, the average inclination, and the instant inclination of the road surface inclination angle measuring device calculated based on the data measured at the measurement time by the third sensor module.

2. The road surface inclination angle measuring device according to claim 1, wherein:
the instant road surface inclination angle calculation module is further configured to calculate the instant road surface inclination angle at the measurement time by correcting the instant inclination of the road surface inclination angle measuring device calculated at the measurement time to an installation inclination of the road surface inclination angle measuring device; and
the installation inclination of the road surface inclination angle measuring device is a difference value between the average inclination and the average road surface inclination angle.

3. The road surface inclination angle measuring device according to claim 1, wherein:
the first sensor module comprises a sensor configured to measure speed data; and
the moving distance calculation module is further configured to calculate the moving distance from the initial time to the measurement time based on speed data measured by the first sensor module from the initial time to the measurement time.

4. The road surface inclination angle measuring device according to claim 1, wherein:
the first sensor module comprises a sensor configured to measure a global positioning system (GPS) data; and
the moving distance calculation module is further configured to calculate the moving distance from the initial time to the measurement time based on GPS data measured by the first sensor module at the initial time and GPS data measured by the first sensor module at the measurement time.

5. The road surface inclination angle measuring device according to claim 1, wherein the second sensor module is an air pressure sensor.

6. The road surface inclination angle measuring device according to claim 1, wherein the third sensor module is an acceleration sensor.

7. A road surface inclination angle measuring device installed in a moving object and configured to measure an instant road surface inclination angle, the road surface inclination angle measuring device comprising:
a sensor module configured to measure first data for calculating a moving distance, measure second data for calculating an altitude, and measure third data for calculating an instant inclination of the road surface inclination angle measuring device; and
a calculation module configured to calculate the instant road surface inclination angle at a predetermined measurement time,
wherein the calculation module comprises:
a moving distance calculation module configured to calculate a moving distance from a predetermined initial time to the measurement time based on the first data measured by the sensor module;
an altitude difference calculation module configured to calculate an altitude difference that is a difference between an altitude at the initial time and an altitude at the measurement time based on the second data measured by the sensor module;
an average road surface inclination angle calculation module configured to calculate an average road surface inclination angle based on the moving distance and the altitude difference;
an average inclination calculation module configured to calculate an average inclination which is an average value of instant inclinations of the road surface inclination angle measuring device, based on the third data measured by the sensor module from the initial time to the measurement time; and
an instant road surface inclination angle calculation module configured to calculate the instant road surface inclination angle at the measurement time based on the average road surface inclination angle, the average inclination, and the instant inclination of the road surface inclination angle measuring device calculated based on the third data measured at the measurement time by the sensor module.

8. A road surface inclination angle measuring method performed by a road surface inclination angle measuring device which is installed in a moving object, the road surface inclination angle measuring device including a first sensor module configured to measure data for calculating a moving distance; a second sensor module configured to measure data for calculating an altitude; and a third sensor module configured to measure data for calculating an instant inclination of the road surface inclination angle measuring device,
the road surface inclination angle measuring method comprising:
calculating a moving distance from a predetermined initial time to a predetermined measurement time based on the data measured by the first sensor module;
calculating an altitude difference that is a difference between an altitude at the initial time and an altitude at the measurement time based on the data measured by the second sensor module;
calculating an average road surface inclination angle based on the moving distance and the altitude difference;
calculating an average inclination which is an average value of instant inclinations of the road surface inclination angle measuring device, based on the data measured by the third sensor module from the initial time to the measurement time; and
calculating the instant road surface inclination angle at the measurement time based on the average road surface inclination angle, the average inclination, and the instant inclination of the road surface inclination angle measuring device calculated based on the data measured at the measurement time by the third sensor module.

9. The road surface inclination angle measuring method according to claim 8, wherein:
the instant road surface inclination angle calculation step comprises calculating the instant road surface inclination angle at the measurement time by correcting the instant inclination of the road surface inclination angle measuring device calculated at the measurement time to an installation inclination of the road surface inclination angle measuring device; and
the installation inclination of the road surface inclination angle measuring device is a difference value between the average inclination and the average road surface inclination angle.

10. A road surface inclination angle measuring method performed by a road surface inclination angle measuring device which is installed in a moving means, the road surface inclination angle measuring device including a sensor module configured to measure first data for calculating a moving distance, measure second data for calculating an altitude, and measure third data for calculating an instant inclination of the road surface inclination angle measuring device,
wherein the road surface inclination angle measuring method comprises:
calculating a moving distance from a predetermined initial time to the measurement time based on the first data measured by the sensor module;
calculating an altitude difference that is a difference between an altitude at the initial time and an altitude at the measurement time based on the second data measured by the sensor module;
calculating an average road surface inclination angle based on the moving distance and the altitude difference;
calculating an average inclination which is an average value of instant inclinations of the road surface inclination angle measuring device, based on the third data measured by the sensor module from the initial time to the measurement time; and
calculating the instant road surface inclination angle at the measurement time based on the average road surface inclination angle, the average inclination, and the instant inclination of the road surface inclination angle measuring device calculated based on the third data measured at the measurement time by the sensor module.

11. A computer program installed in a data processing device and stored in a recording medium for performing the method according to claim 8.

12. A road surface inclination angle measuring device installed in a moving object, the road surface inclination angle measuring device comprising:
a sensor module configured to measure first data for calculating a moving distance, measure second data for calculating an altitude, and measure third data for calculating an instant inclination of the road surface inclination angle measuring device;
a processor; and
a memory storing a computer program executed by the processor,
wherein the computer program allows the road surface inclination angle measuring device to perform the method according to claim 8 when the computer program is executed by the processor.

13. A computer program installed in a data processing device and stored in a recording medium for performing the method according to claim 10.

14. A road surface inclination angle measuring device installed in a moving object, the road surface inclination angle measuring device comprising:
a sensor module configured to measure first data for calculating a moving distance, measure second data for calculating an altitude, and measure third data for calculating an instant inclination of the road surface inclination angle measuring device;
a processor; and
a memory storing a computer program executed by the processor,
wherein the computer program allows the road surface inclination angle measuring device to perform the method according to claim 10 when the computer program is executed by the processor.
